(19) United States
(12) Patent Application Publication
(10) Pub. No.: US 2026/0356389 A1
(43) Pub. Date: Nov. 12, 2026

(54) PROVIDING REAL TIME BIRD'S EYE VIEW WITH REALITY CHECKS FOR DRIVING

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/204,638

(22) Filed: May 12, 2025

(51) Int. Cl. B60W 60/00; G06V 10/82; G06V 20/17; G06V 20/56

(52) U.S. Cl. CPC B60W 60/001; G06V 10/82; G06V 20/17; G06V 20/56; B60W 2556/35

(57) ABSTRACT

A computer-implemented method of providing real-time air view for driving, the computer-implemented method includes obtaining ground view data being sensed in real-time by at least one sensor in a region of view of a ground vehicle; obtaining air based data pertaining to a driving environment of the ground vehicle that corresponds to the region of view; generating, by using a machine learning process, embeddings of the ground view data and the air based data, wherein the machine learning process is trained across environmental driving related data of collected images to produce embeddings for road elements in the collected images; and producing an augmented air based view with reality checks in the air based data for autonomous driving, by adding road elements that are represented by at least one of the embeddings generated based on the ground view data into the augmented air based view.

### BACKGROUND

Artificial intelligence models for driving require vast amount of training information.

Gathering training information by using ground vehicle images per-se suffer from known limitations of image acquisition such as occlusions, inaccuracies associated with locations, and the like.

There is a growing need to improve the variety, and the accuracy of information used for training of artificial intelligence models.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a vehicle;

FIG. 3 illustrates an example of a method;

FIG. 4A. 4B, and 4C illustrate examples of producing an augmented air based image; and

FIG. 5 illustrates an example of a method.

### DETAILED DESCRIPTION

There is provided a method, a non-transitory computer readable medium and a system for providing real-time air view for driving-especially for generating augmented air based view in real time, without needing to constantly upload air based data that is not necessarily updated. The augmented air based view accurately represents the real-time sensed driving environment, ensuring precise perception (detection, distance, velocity and orientation estimation), of all road elements relative to the ego vehicle.

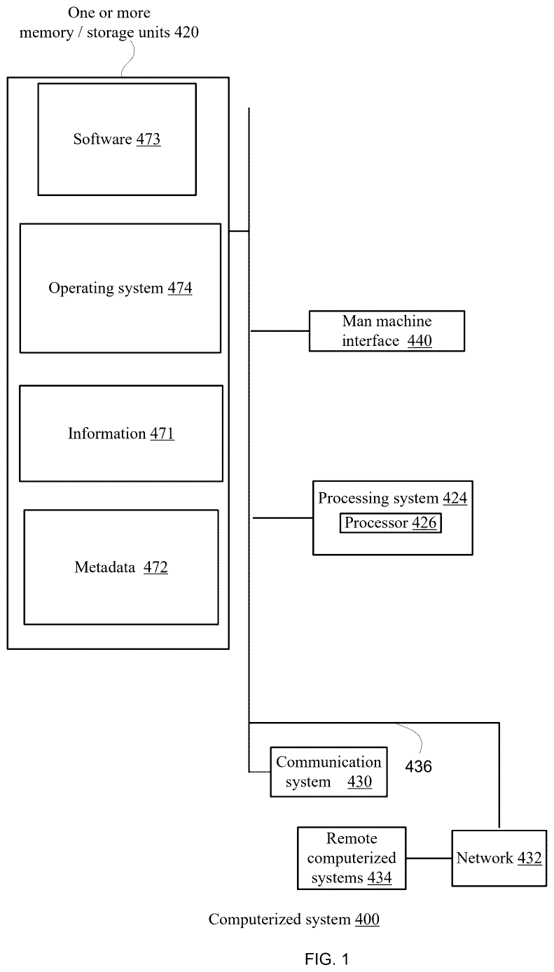

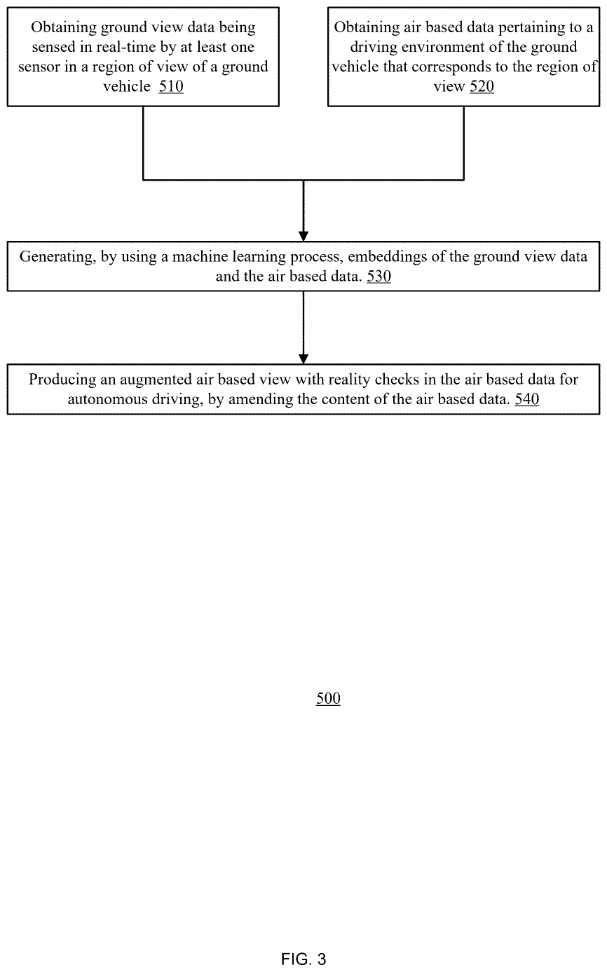

FIG. 1 illustrates an example of a computerized system 400 that is configured to execute at least some of the steps of method 500 of FIG. 3.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

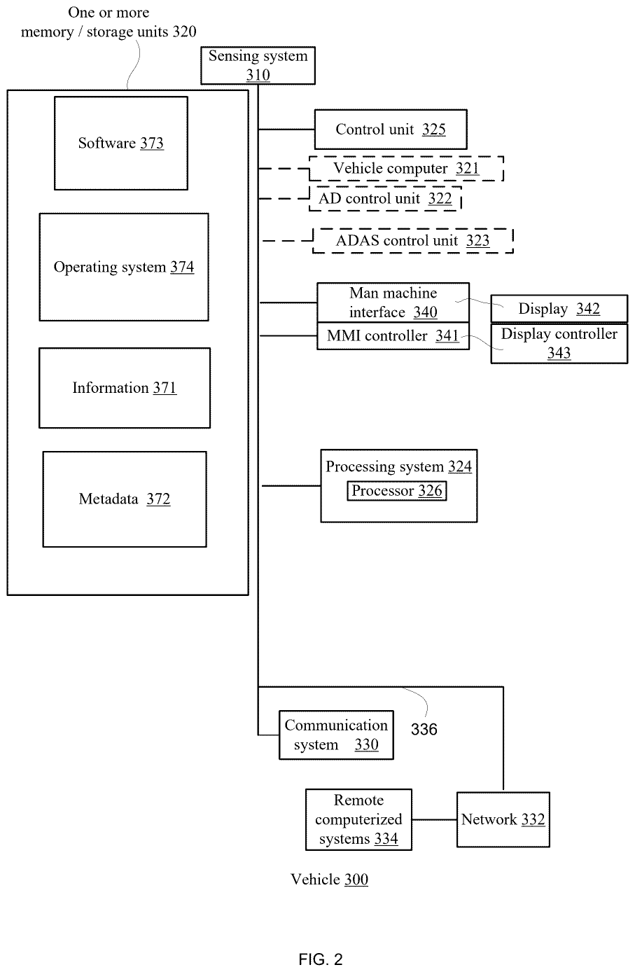

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example-any reference to processor should be applied mutatis mutandis to multiple processors, any reference to communication system 430 should be applied mutatis mutandis to multiple communication systems.

According to an embodiment, the memory and/or storage units 420 stores at least one of: operating system 474, information 471, metadata 472, and software 473.

According to an embodiment, processing system 424 is configured to perform any method illustrated in the application while executing software.

FIG. 2 illustrates an example of vehicle 300 configured to utilize the augmented air based view generated by method 500 of FIG. 3 and/or to participate in the execution of method 500.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks-at least some of which are not currently stored in the vehicle.

According to an embodiment, the memory and/or storage unit 320 stores at least one of: operating system 374, information 371, metadata 372, and software 373.

The control unit 325 may cooperate with ADAS control unit 323 and/or with AD control unit 322 and/or may control or communicate with other vehicle components-including vehicle computer.

The ADAS control unit 323 is configured to control ADAS operations.

The AD control unit 322 is configured to control autonomous driving of the autonomous vehicle.

The vehicle computer 321 is configured to control the operation of the vehicle-especially controlling the engine, the transmission, and any other vehicle system or component.

The vehicle computer 321 may be in communication with an engine control module, a transmission control module, a powertrain control module, and the like.

FIG. 3 illustrates an example of method 500 of providing real-time air view for driving, the method is computer implemented.

According to an embodiment, method 500 includes step 510 of obtaining ground view data being sensed in real-time by at least one sensor in a region of view of a ground vehicle. Real-time may be acquiring the ground vide data multiple times a second, each few seconds, multiple times per minute, and the like.

According to an embodiment, method 500 includes step 520 of obtaining air based data pertaining to a driving environment of the ground vehicle that corresponds to the region of view.

The air based data may be preloaded, may be acquired from a remote sensor, may be gathered by remote sensing imagery, may be acquired from a satellite, from a drone, from an airplane, and the like. The air based data may be uploaded to a vehicle once or at a relative low frequency-for example once per week, one per month, and the like. The air based data may be regarded as off-line, not real time or older than the ground view data being sensed in real-time.

According to an embodiment, method includes step 530 of generating, by using a machine learning process, embeddings of the ground view data and the air based data.

According to an embodiment the embeddings include ground view embeddings and air based embeddings that are located in a shared embedding space.

According to an embodiment, the generating of the ground view embeddings may follow step 510, and the generating of the air based embeddings may follow step 520.

According to an embodiment, more than a single machine learning process is used to generate the embeddings-for example one for the generating of the ground view embeddings and another for the generating of the air based embeddings.

The machine learning process may be trained across collected environmental driving related data containing training ground view data and corresponding training air based data to produce respective joint embeddings each from a respective pair of the training ground view data and the training corresponding air based data.

According to an embodiment, the ground view embeddings and the air based embeddings are joint embeddings in the sense that a road element is represented by a ground view embedding that is similar to an air based embedding of the road object. When joint embeddings are use the machine learning process user similarity between embeddings to represent the relationship between the road elements.

According to an embodiment, when not using joint embeddings, the training process, given a knowledge of the road elements provided during the training ma provide a mapping (that may be even stored outside of the machine learning process between embeddings and road elements represented by the embeddings).

According to an embodiment, the method also uses a mapping between road elements (represented by embeddings) and their appearance in an air based view-to be sued by adding and/or removing and/or changing road elements from the augmented air view.

According to an embodiment, there is no defined relationship between a ground view embedding and an air based embedding of the same road element.

According to an embodiment, step 530 is followed by step 540 of producing an augmented air based view with reality checks in the air based data for autonomous driving, by amending the content of the air based data. The produced augmented air based view may be of an augmented real time air based image view, providing real time bird's eye image view. The produced augmented air based view may be an augmented real-time air-based view video providing real time streaming of air-based video streams with reality checks in the image view.

The reality checks indicate that the producing of the augmented air based view is based on actual sensed ground view information.

According to an embodiment, the amending may include at least one of:
Adding one or more road elements that appear in the ground view data but did not appear in the air based data.
Removing one or more road elements from the air based data-for example based on their absence in the ground view data and/or being dynamic road elements that only temporarily appear in the region of view.
Changing at least one aspect of appearance (for example location, size, shape, color, orientation) of one or more road elements to comply with their appearance in the ground view data.

According to an embodiment, the producing is based on having the one or more road elements represented by at least one of the embeddings generated based on the ground view data into the augmented air based view.

According to an embodiment, step 540 includes at least one of:
Processing, by a processing unit in a real-time driving of the ground vehicle, the ground view data in accordance with corresponding air based data, wherein the generating of the embeddings is based on the processing.
Analyzing the embeddings to detect one or more road elements within the ground view data and/or to detect one or more road elements within the air based data.
Analyzing the embeddings to localizing of the one or more road elements within the ground view data and/or to localize one or more road elements within the air based data.
Using any of the one or more road elements as anchors for aligning the ground view data with the air based data.
Mapping between embeddings of the ground view data and corresponding embeddings of the air based data.
Using the road elements represented by the embeddings (that are also indicative of localization information of given road elements) as anchors.
Determining locations of the added road elements within the augmented air based view based on the localization information of the given road elements.
Calculating a footprint of the added road elements. For example-their projection on the road.
Providing an augmented air based view that includes one or more real time generated augmented air view images.
Providing an augmented air based view that includes one or more real time generated augmented air view video streams.
Determining real-time localization of the ground vehicle, using the embeddings

According to an embodiment, a road element is being detected, and its location is sorted out-but its footprint may include calculating the vertical projection of the road element. This may require searching for a contact point between the road element and the road (for example where wheels of a vehicle contact the ground, where a pedestrian stands, and the like—whereas this may include using a machine learning process to determine the projection and/or use another process. When only a portion of the road element is visible the projection may take into account the shape and size of the road element—as the vehicle model, and the like. The footprint may define the borders of the representation of the road element in the augmented air based view.

The anchors may be set in, or with respect to, specific driving scenarios. For example, when the scenario includes a roundabout then the roundabout may be used as an anchor being static and having a unique shape. When the scenario includes a combination of time and a location then a road element that can be seen at night will be selected as an anchor when the scenario involves driving through the location at night—and another element that can be seen only during day will be selected as an anchor for the scenario that includes driving through the location during the day.

The real-time augmented air based view may be provided for use in autonomous driving and/or for autonomous driving applications.

Providing the real-time augmented air based view for use in autonomous driving may involve one or more of:
Generating one or more training datasets including multiple augmented air based views.
Using one or more augmented air based views for training one or more artificial intelligence modules for autonomous driving.
Using one or more artificial intelligence model (following training) for autonomous driving during inference-in relation to autonomous driving.
Using one or more artificial intelligence model (following training) for autonomous driving during inference by generating and/or requesting and/or determining and/or instructing and/or triggering and/or controlling and/or transmitting and/or outputting and/or preforming at least one autonomous or non-autonomous driving related operation is associated with the artificial intelligence models below a maturity level, and/or driving along the path-for example in compliant with one or more levels of autonomous driving-such as L2, L2+, L2++, L3 or L4 autonomous driving.
Populating a database with one or more augmented air based views. This data base may reside in one or more memory and/or storage units.

According to an embodiment, the method includes using the training information (including one or more augmented air based views) for training any number of artificial intelligence models-such as more than 10, 100, 1,000, 10,000, 100,000, 1,000,000, 10,000,000 and the like.

According to an embodiment, the training of the one or more artificial intelligence models may be of any type of training-supervised, unsupervised, semi-supervised learning, reinforcement learning, and the like.

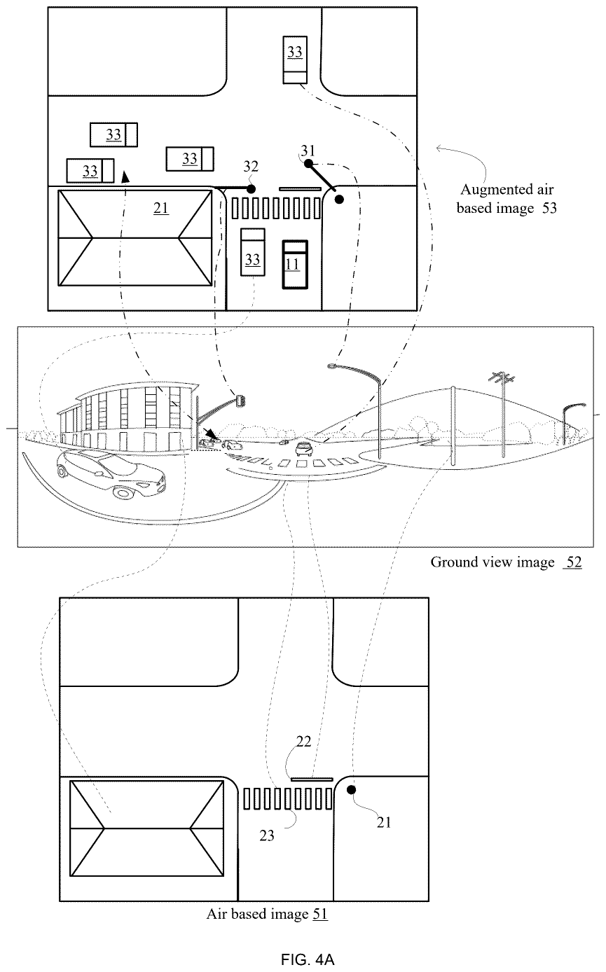

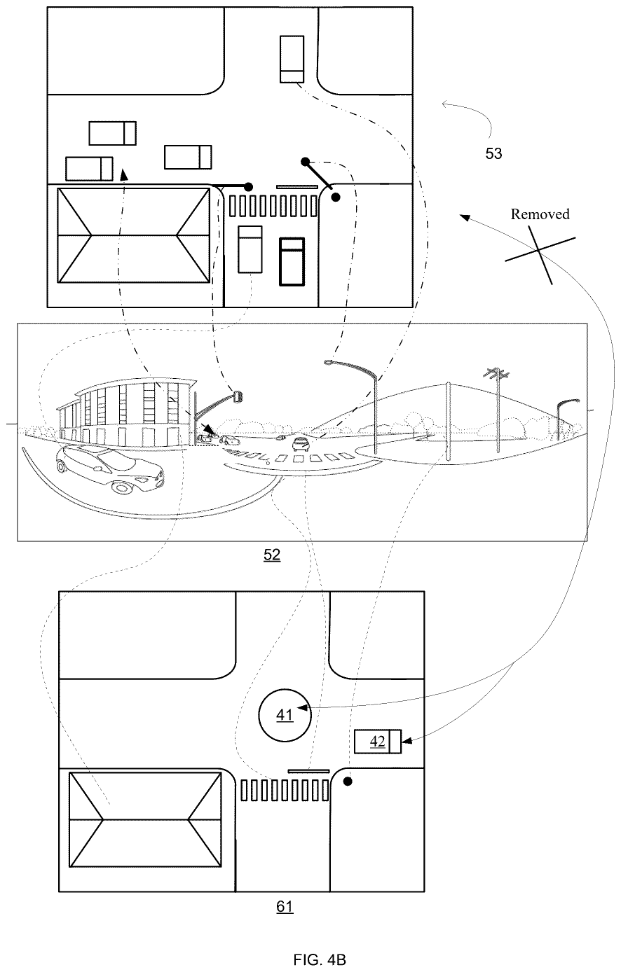

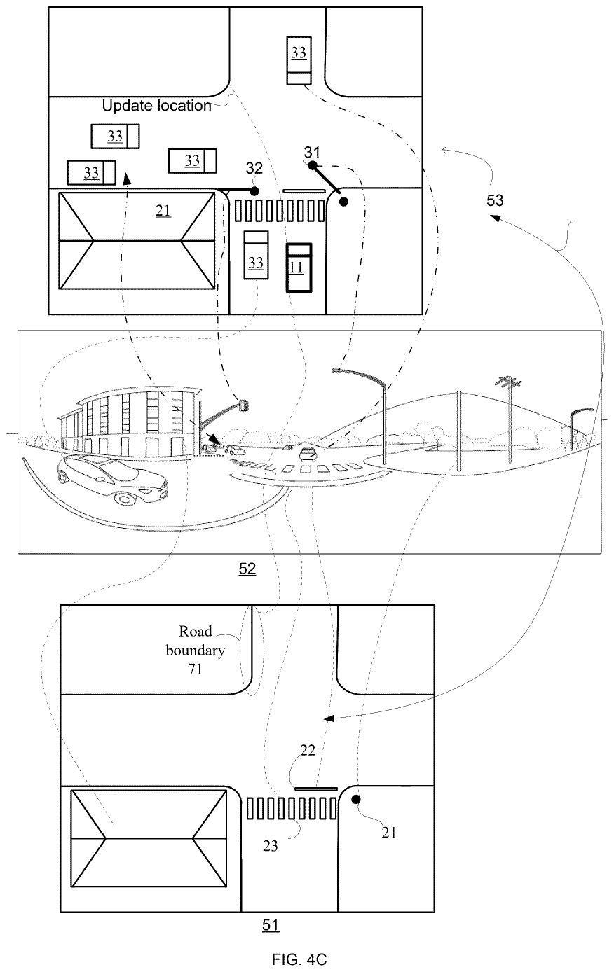

FIG. 4A illustrates an example of adding one or more road elements that appear in the ground view data but did not appear in the air based data.

FIG. 4B illustrates an example of removing one or more road elements from the air based data—for example based on their absence in the ground view data and/or being dynamic road elements that only temporarily appear in the region of view.

FIG. 4C illustrates an example of changing at least one aspect of appearance (for example location, size, shape, color, orientation) of one or more road elements to comply with their appearance in the ground view data.

In FIGS. 4A-4C there is provided an air based view such as air based image 51 that captures a building 21 that is positioned adjacent to a junction. A road segment that leads to the junction includes a road crossing 23, a delimiting line 22 positioned downstream to part of the road crossing, and a utility pole 21.

FIGS. 4A-AC also illustrate ground view data such as ground view image 52 that shows the road elements of air based image 51, as well as a street lighting pole 31, traffic light 32 and one or more vehicles 33 (other than ego vehicle 11 that is the ground vehicle that generated the ground view image).

In FIG. 4A the augmented air based view-such as augmented air based image 53 has been processed, and amended to add representations of (air based visual representations of) street lighting pole 31, traffic light 32, one or more vehicles 33 and ego vehicle 11.

In FIG. 4B, illustrating an example of removing road elements (or not showing the road elements) such as roundabout 41 that appeared in the air based image 51—but removed before the acquisition of ground view image 52, and of irrelevant vehicle 42 (being a dynamic road element appearing in the air based image 51).

In FIG. 4C, illustrating an example of changing at least one aspect of appearance of one or more road elements from the air based data—for example based on their absence in the ground view data and/or being dynamic road elements that only temporarily appear in the region of view. In this figure road boundary 71 was moved to a new location based on the ground view image.

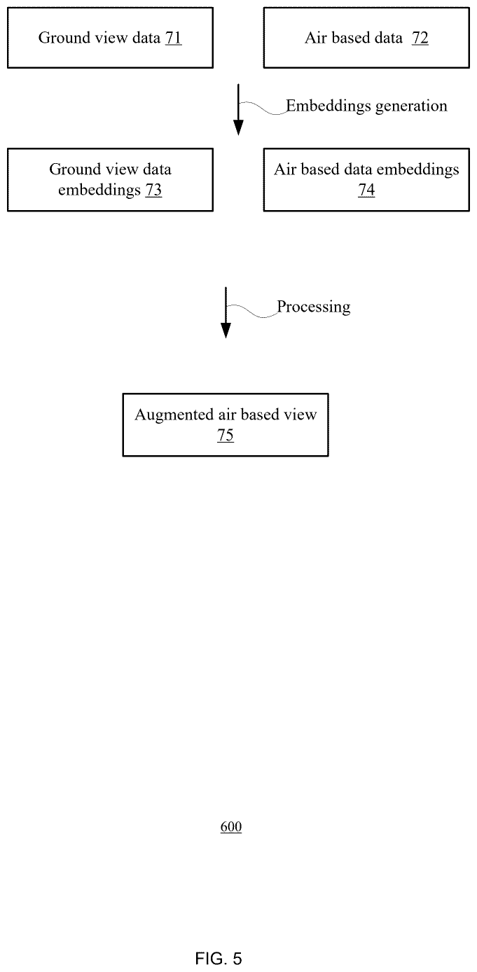

FIG. 5 illustrates an example of a method that includes receiving ground view data 71 and air based data 72, generating embeddings such as ground view data embeddings 72 and air based data embeddings 74 and processing the embeddings to provide augmented air based view.

Assuming that the embeddings (ground view data embeddings 72 and air based data embeddings 74) are joint embeddings than they are projected into a shared embedding space.

This allows models to compare, relate, or retrieve data across the ground view data and the air based data.

According to an embodiment:
The ground view data embeddings are generated using one encoder (for example a Convolutional Neural Network) and the air based data embeddings are generated using another encoder.
Outputs from these encoders are projected into a common embedding space using learned linear transformations or neural layers.
Techniques like contrastive loss (e.g., InfoNCE) are used to bring semantically similar items closer and dissimilar items farther apart.

The embeddings may be generated, or allocated per pixel (while taking into account values of other pixels—for example pixels within a vicinity of the pixel) or per segment (for example a group of pixels, a rectangular shaped segment or any other segments. The segments may be defined by using content based segmentation.

An embedding of any type may be indicative of one or more road element or a portion of a road element. Location information may be explicitly included in the embedding or may be implicitly associated with the embedding (especially when the embedding is allocated to a certain segment of pixel of the data.

The processing includes detecting one or more road elements and their locations based on the embeddings.

The processing may further include identifying, or detecting a corresponding road element that appears in both types of data—i.e. in the air based data and in the ground view data. This may include compensating for differences in the location of a road element-for example by assigning a priority of trust level of accuracy level to the location determination of the road element in each type of the data. In an example, the more updated, recently sensed, ground view data is, the more accurate the older, pre-loaded, air based data can be.

Accordingly, the air based data may be more accurate in case where the field of view of the ground vehicle is partially occluded, obtained in worse lighting conditions, and the like.

In an example, when the same two or more road element used as anchors (for example static road elements) appear in both types of data—their relative location in each one of the data may be used to compensate for tilter or oriented surface or road on which they appear.

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning.

Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example-any reference to a neural network should be applied mutatis mutandis to artificial intelligence and/or should be applied mutatis mutandis to “machine learning”, and/or should be applied mutatis mutandis to “deep learning”.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove.

Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A computer-implemented method of providing real-time air view for driving, the computer-implemented method comprising:
obtaining ground view data being sensed in real-time by at least one sensor in a region of view of a ground vehicle;
obtaining air based data pertaining to a driving environment of the ground vehicle that corresponds to the region of view;
generating, by using a machine learning process, embeddings of the ground view data and the air based data, wherein the machine learning process is trained across environmental driving related data of collected images to produce embeddings for road elements in the collected images;
producing an augmented air based view with reality checks in the air based data for autonomous driving, by adding road elements that are represented by at least one of the embeddings generated based on the ground view data into the augmented air based view;
generating one or more training datasets including multiple augmented air based views.
training one or more artificial intelligence models for autonomous driving using the one or more training datasets; and
using the one or more artificial intelligence models, following the training, for autonomous driving during inference to generate at least one driving related decision.

2. The computer-implemented method of claim 1, further comprising processing, by a processing unit in a real-time driving of the ground vehicle, the ground view data in accordance with corresponding air based data, wherein the generating of the embeddings is based on the processing.

3. The computer-implemented method of claim 1, further comprising mapping between embeddings of the ground view data and corresponding embeddings of the air based data.

4. The computer-implemented method of claim 1, wherein the machine learning process is trained across collected environmental driving related data containing training ground view data and corresponding training air based data to produce respective joint embeddings each from a respective pair of the training ground view data and the training corresponding air based data.

5. The computer-implemented method of claim 1, wherein the embeddings are indicative of localization information of given road elements in an image view, and wherein the producing comprises using the given road elements as anchors.

6. The computer-implemented method of claim 5, wherein the producing comprises determining locations of the added road elements within the augmented air based view based on the localization information of the given road elements.

7. The computer-implemented method of claim 5, wherein the anchors are set in specific driving scenarios.

8. The computer-implemented method of claim 1, wherein the augmented air based view comprises one or more real time generated augmented air view images.

9. The computer-implemented method of claim 1, wherein the augmented air based view comprises one or more real time generated augmented air view video streams.

10. The computer-implemented method of claim 1, wherein the air based data is pre-loaded data.

11. The computer-implemented method of claim 1, further comprising determining real-time localization of the ground vehicle, using the embeddings.

12. The computer-implemented method of claim 1, further comprising providing the augmented air based view in an autonomous driving-related operation of the ground vehicle.

13. The computer-implemented method of claim 1, wherein the producing the augmented air based view comprises calculating a footprint of the added road elements.

14. A non-transitory computer-readable medium storing instructions for real-time air view for driving that, when executed by at least one processing device associated with a vehicle, cause the at least one processing device to:
obtain ground view data being sensed in real-time by at least one sensor in a region of view of a ground vehicle;
obtain air based data pertaining to a driving environment of the ground vehicle that corresponds to the region of view;
generate, by using a machine learning process, embeddings of the ground view data and the air based data, wherein the machine learning process is trained across environmental driving related data of collected images to produce embeddings for road elements in the collected images; and
produce an augmented air based view with reality checks in the air based data for autonomous driving, by adding road elements that are represented by at least one of the embeddings generated based on the ground view data into the augmented air based view;
generating one or more training datasets including multiple augmented air based views.
training one or more artificial intelligence models for autonomous driving using the one or more training datasets; and
using the one or more artificial intelligence models, following the training, for autonomous driving during inference to generate at least one driving related decision.

15. The non-transitory computer-readable medium of claim 14, further storing instructions causing the processing device to process, in a real-time driving of the ground vehicle, the ground view data in accordance with corresponding air based data, wherein the generating of the embeddings is based on the processing.

16. The non-transitory computer-readable medium of claim 14, further storing instructions causing the processing device to map between embeddings of the ground view data and corresponding embeddings of the air based data.

17. The non-transitory computer-readable medium of claim 14, wherein the machine learning process is trained across collected environmental driving related data containing training ground view data and corresponding training air based data to produce respective joint embeddings each from a respective pair of the training ground view data and the training corresponding air based data.

18. The non-transitory computer-readable medium of claim 14, wherein the embeddings are indicative of localization information of given road elements in an image view, and wherein the producing comprises using the given road elements as anchors.

19. The non-transitory computer-readable medium of claim 18, wherein the producing comprises determining locations of the added road elements within the augmented air based view based on the localization information of the given road elements.

20. A system for real-time air view for driving, comprising:
a memory configured to store air based data pertaining to a driving environment of a ground vehicle that corresponds to a region of view of the ground vehicle; and
a processor configured to:
obtain ground view data being sensed in real-time by at least one sensor in the region of view of the ground vehicle;
obtain the air based data;
generate, by using a machine learning process, embeddings of the ground view data and the air based data, wherein the machine learning process is trained across environmental driving related data of collected images to produce embeddings for road elements in the collected images;
produce an augmented air based view with reality checks in the air based data for autonomous driving, by adding road elements that are represented by at least one of the embeddings generated based on the ground view data into the augmented air based view;
generating one or more training datasets including multiple augmented air based views.
training one or more artificial intelligence models for autonomous driving using the one or more training datasets; and
using the one or more artificial intelligence models, following the training, for autonomous driving during inference to generate at least one driving related decision.

21. A computer-implemented method of providing real-time air view for driving, the computer-implemented method comprising:
obtaining ground view data being sensed in real-time by at least one sensor in a region of view of a ground vehicle;
obtaining air based data pertaining to a driving environment of the ground vehicle that corresponds to the region of view;
generating, by using a machine learning process, embeddings of the ground view data and the air based data, wherein the machine learning process is trained across environmental driving related data of collected images to produce embeddings for road elements in the collected images; and
producing an augmented air based view with reality checks in the air based data for autonomous driving, by adding road elements that are represented by at least one of the embeddings generated based on the ground view data into the augmented air based view; wherein the embeddings comprise ground view embeddings and air based embeddings that are located in a shared embedding space, and wherein a similarity between a ground view embedding and an air based embedding in the shared embedding space is indicative of a same road element; wherein the ground view embeddings are generated using a first encoder, the air based embeddings are generated using a second encoder, outputs of the first and second encoders are projected into the shared embedding space, and the machine learning process is trained using a contrastive loss to bring embeddings of semantically similar items closer together and embeddings of dissimilar items farther apart.
